(19) United States
(12) Patent Application Publication
(10) Pub. No.: US 2018/0196273 A1
(43) Pub. Date: Jul. 12, 2018

(54) THREE-DIMENSIONAL DISPLAY PANEL ASSEMBLY, DISPLAY APPARATUS HAVING THE SAME, AND FABRICATING METHOD THEREOF

(71) Applicant: BOE TECHNOLOGY GROUP CO., LTD., Beijing (CN)

(72) Inventor: Kun Wu, Beijing (CN)

(73) Assignee: BOE TECHNOLOGY GROUP CO., LTD., Beijing (CN)

(21) Appl. No.: 15/533,510

(22) PCT Filed: Dec. 16, 2016
(86) PCT No.: PCT/CN2016/110324

§ 371 Date: Jun. 6, 2017

(30) Foreign Application Priority Data
Jun. 28, 2016 (CN) 201610489515.1

(51) Int. Cl. G02B 27/22

(52) U.S. Cl. CPC G02B 27/2214

(57) ABSTRACT

The present application discloses a three-dimensional display panel assembly, including a display panel having a light emitting side and an array of subpixels arranged in a matrix along a first direction and a second direction; and a grating layer on the light emitting side of the display panel having a plurality of grating units, each of the plurality of grating units configured to direct light emitted from at least three adjacent subpixels into a first view zone and a second view zone on a side of the grating layer distal to the display panel.

### CROSS-REFERENCE TO RELATED APPLICATION

This application claims priority to Chinese Patent Application No. 201610489515.1, filed Jun. 28, 2016, the contents of which are incorporated by reference in the entirety.

### TECHNICAL FIELD

The present invention relates to display technology, more particularly, to a three-dimensional display panel assembly, a display apparatus having the same, and a fabricating method thereof.

### BACKGROUND

In recent years, naked eye three-dimensional display apparatuses have become a focus of research and development. Typically, the naked eye three-dimensional display apparatuses use either a parallax barrier grating or a lenticular lens grating. The naked eye three-dimensional display apparatuses obviate the need of wearing a glass, making the viewing experience more pleasant and convenient.

### SUMMARY

In one aspect, the present invention provides a three-dimensional display panel assembly, comprising a display panel comprising a light emitting side and an array of subpixels arranged in a matrix along a first direction and a second direction; and a grating layer on the light emitting side of the display panel comprising a plurality of grating units, each of the plurality of grating units configured to direct light emitted from at least three adjacent subpixels into a first view zone and a second view zone on a side of the grating layer distal to the display panel.

Optionally, each of the plurality of grating units has a grating pitch substantially the same as a width of the at least three adjacent subpixels.

Optionally, the plurality of grating units are arranged along a longitudinal direction of the display panel, each of the plurality of grating units extending along a lateral direction of the display panel.

Optionally, each of the plurality of grating units configured to direct light emitted from at least a first subpixel of the at least three adjacent subpixels into the first view zone, and direct light emitted from at least a second subpixel of the at least three adjacent subpixels into the second view zone.

Optionally, the at least three adjacent subpixels are at least three adjacent subpixels along the first direction.

Optionally, the at least three adjacent subpixels are at least three adjacent subpixels along the second direction.

Optionally, the at least three adjacent subpixels are 3N adjacent subpixels, N is a positive integer.

Optionally, N=1.

Optionally, the grating layer is a parallax barrier grating layer, each of the plurality of grating units comprises a barrier part and a slit part, the slit part is light transmissive, the barrier part is light blocking.

Optionally, the parallax barrier grating layer comprises a plurality of slits arranged along a longitudinal direction of the display panel, each of the plurality of slits extending along a lateral direction of the display panel.

Optionally, the grating layer is a lenticular lens grating layer, each of the plurality of grating units comprises a cylindrical lens.

Optionally, the lenticular lens grating layer comprises a plurality of cylindrical lenses arranged along a longitudinal direction of the display panel, a central axis of each of the plurality of cylindrical lenses extending along a lateral direction of the display panel.

Optionally, each of the plurality of grating units has a viewing range of approximately 55 mm to approximately 60 mm at a viewing distance in a range of approximately 300 mm to approximately 400 mm.

Optionally, the display panel further comprising a color filter layer; and a normal distance between the color filter layer and the grating layer is greater than approximately 0.4 mm.

Optionally, the plurality of grating units are arranged substantially along the first direction of the display panel, each of the plurality of grating units forming an acute angle with the second direction of the display panel.

In another aspect, the present invention provides a method of fabricating a three-dimensional display panel assembly, comprising providing a display panel comprising a light emitting side and an array of subpixels arranged in a matrix along a first direction and a second direction; and forming a grating layer on the light emitting side of the display panel, the grating layer comprising a plurality of grating units, each of the plurality of grating units configured to direct light emitted from at least three adjacent subpixels into a first view zone and a second view zone on a side of the grating layer distal to the display panel.

Optionally, forming the grating layer comprises providing a grating layer having a grating pitch substantially the same as a width of the at least three adjacent subpixels; and adhering the grating layer to the light emitting side of the display panel.

Optionally, prior to adhering the grating layer to the light emitting side of the display panel, further comprising arranging the grating layer so that the plurality of grating units are arranged along a longitudinal direction of the display panel, each of the plurality of grating units extending along a lateral direction of the display panel.

Optionally, prior to adhering the grating layer to the light emitting side of the display panel, further comprising arranging the grating layer so that the plurality of grating units are arranged substantially along the first direction of the display panel, each of the plurality of grating units forming an acute angle with the second direction of the display panel.

In another aspect, the present invention provides a three-dimensional display apparatus comprising a three-dimensional display panel assembly described herein or fabricated by a method described herein.

### BRIEF DESCRIPTION OF THE FIGURES

The following drawings are merely examples for illustrative purposes according to various disclosed embodiments and are not intended to limit the scope of the present invention.

FIG. 1 is a schematic diagram illustrating the structure of a conventional three-dimensional display panel assembly.

FIG. 2A is a diagram illustrating the structure of a three-dimensional display panel assembly in some embodiments according to the present disclosure.

FIG. 2B is a diagram illustrating the structure of a grating layer in some embodiments according to the present disclosure.

FIG. 3 is a schematic diagram illustrating an increased focal length in a grating layer in some embodiments according to the present disclosure.

FIG. 4 is a diagram illustrating the structure of a cylindrical lens in some embodiments according to the present disclosure.

FIG. 5 is a diagram illustrating a viewing range in a three-dimensional display panel assembly in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

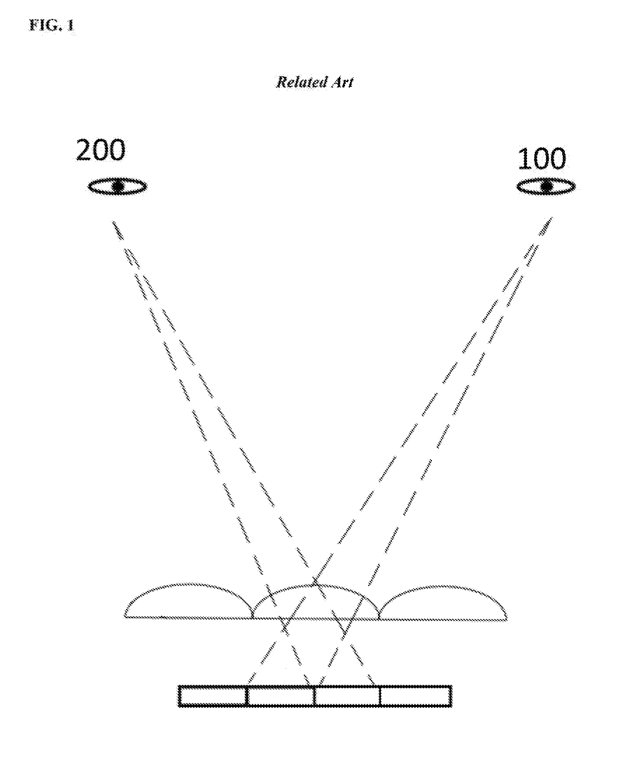

FIG. 1 is a schematic diagram illustrating the structure of a conventional three-dimensional display panel assembly. Referring to FIG. 1, each grating unit in the conventional three-dimensional display panel assembly corresponds to two adjacent subpixels. In recent years, display apparatuses such as mobile phones are made of high resolutions. For example, some mobile phones have a resolution of more than 4000, e.g., 3840×2160. To achieve a normal viewing distance of 300 mm to 400 mm, the grating layer has to be disposed at a distance of 0.18 mm to 0.25 mm from the two-dimensional display panel. This is infeasible in the display panel without redesigning the layout and structure of the display panel because the distance between a subpixel and a light emitting surface (e.g., the outer surface of a color filter layer) in a display panel is at least approximately 0.4 mm considering the thicknesses of a glass cover, a polarizer, and a protective film. When a user is viewing the three-dimensional image in a conventional display panel assembly, the three-dimensional effects are compromised.

Accordingly, the present invention provides, inter alia, a three-dimensional display panel assembly, a display apparatus having the same, and a fabricating method thereof that substantially obviate one or more of the problems due to limitations and disadvantages of the related art. In one aspect, the present disclosure provides a three-dimensional display panel assembly. In some embodiments, the three-dimensional display panel assembly includes a display panel having an array of subpixels arranged in a matrix along a first direction and a second direction; and a grating layer having a plurality of grating units. Optionally, the display panel has a light emitting side from which light is emitted to the outside of the display panel for image display, and a light incident side at which incident light (e.g., light from a back light) enters. Optionally, the grating layer is on the light emitting side of the display panel, and each of the plurality of grating units is configured to direct light emitted from at least three adjacent subpixels into a first view zone and a second view zone on a side of the grating layer distal to the display panel. Optionally, the grating layer is on the light incident side of the display panel, e.g., between the display panel and a back light, each of the plurality of grating units is configured to direct light into at least three adjacent subpixels so that light emitted from at least three adjacent subpixels into a first view zone and a second view zone on a side of the grating layer distal to the display panel.

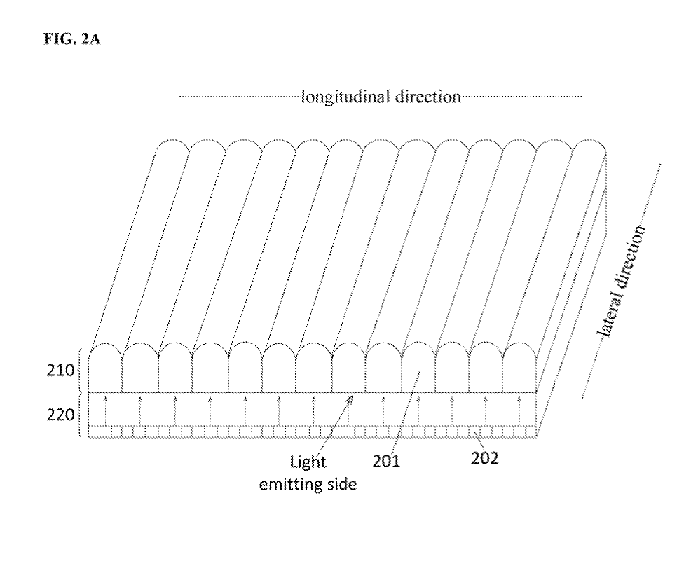

FIG. 2A is a diagram illustrating the structure of a three-dimensional display panel assembly in some embodiments according to the present disclosure. Referring to FIG. 2A, the three-dimensional display panel assembly includes a display panel 210 having a light emitting side and an array of subpixels 202 arranged in a matrix along a first direction (longitudinal direction) and a second direction (lateral direction), and a grating layer 220 on the light emitting side of the display panel 210 having a plurality of grating units 201. The plurality of grating units 201 are arranged along a longitudinal direction of the display panel 210. Each of the plurality of grating units 201 extends along a lateral direction of the display panel.

As used herein, the term “longitudinal direction” refers to a direction parallel to a long side (e.g., the longest side) of an object or a surface. As used herein, the term “lateral direction” refers to a direction parallel to a short side (e.g., the shortest side) of an object or a surface.

FIG. 2B is a diagram illustrating the structure of a grating layer in some embodiments according to the present disclosure. Referring to FIG. 2B, each grating unit 201 corresponds to at least three subpixels 202 in the display panel. The grating unit 201 has a grating pitch P substantially the same as a width of the at least three adjacent subpixels 202. The grating unit 201 is capable of directing light emitted from at least three adjacent subpixels into a first view zone 100 (e.g., a left eye) and a second view zone 200 (e.g., a right eye) on a side of the grating layer distal to the display panel. Each of the plurality of grating units 201 is configured to direct light emitted from at least a first subpixel (e.g., subpixel 202a) of the at least three adjacent subpixels 202 into the first view zone 100, and direct light emitted from at least a second subpixel (e.g., subpixels 202b and 202c) of the at least three adjacent subpixels 202 into the second view zone 200. As shown in FIG. 2B, each grating unit 201 corresponds to three subpixels 202. The grating unit 201 is configured to direct light emitted from one subpixel 202a into the first view zone 100, and direct light emitted from two subpixels 202b and 202c into the second view zone 200.

Optionally, the first view zone 100 is a left eye view zone corresponding to a human's left eye. Optionally, the second view zone 200 is a right eye view zone corresponding to a human's right eye.

In FIG. 2B, each grating unit 201 covers three subpixels 202. Optionally, each grating unit 201 covers more than three subpixels 202. For example, each grating unit 201 may be configured to direct light emitted from four, five, six, or more adjacent subpixels into a first view zone 100 and a second view zone 200 on a side of the grating layer distal to the display panel, i.e., each grating unit 201 has a grating pitch P substantially the same as a width of four, five, six, or more adjacent subpixels. Optionally, each grating unit 201 is configured to direct light emitted from 3N adjacent subpixels, N is a positive integer. Optionally, N=1. In some embodiments, each grating unit 201 is configured to direct light emitted from 3N adjacent subpixels, N is a positive integer. Optionally, N=1.

In FIG. 2A, each grating unit 201 has a grating pitch substantially the same as a width of the at least three adjacent subpixels 202 along the longitudinal direction of the display panel. Optionally, each grating unit 201 has a grating pitch substantially the same as a width of the at least three adjacent subpixels 202 along the lateral direction of the display panel. Optionally, the plurality of grating units 201 are arranged along a longitudinal direction of the display panel, each of the plurality of grating units 201 extending along a lateral direction of the display panel, and each grating unit 201 has a grating pitch substantially the same as a width of the at least three adjacent subpixels 202 along the longitudinal direction of the display panel. Optionally, the plurality of grating units 201 are arranged along a lateral direction of the display panel, each of the plurality of grating units 201 extending along a longitudinal direction of the display panel, and each grating unit 201 has a grating pitch substantially the same as a width of the at least three adjacent subpixels 202 along the lateral direction of the display panel.

Optionally, the plurality of grating units 201 are arranged substantially along a longitudinal direction of the display panel, each of the plurality of grating units 201 forming an acute angle with a lateral direction of the display panel, and each grating unit 201 has a grating pitch substantially the same as a width of the at least three adjacent subpixels 202 along the longitudinal direction of the display panel. Optionally, the plurality of grating units 201 are arranged along a lateral direction of the display panel, each of the plurality of grating units 201 forming an acute angle with a longitudinal direction of the display panel, and each grating unit 201 has a grating pitch substantially the same as a width of the at least three adjacent subpixels 202 along the lateral direction of the display panel.

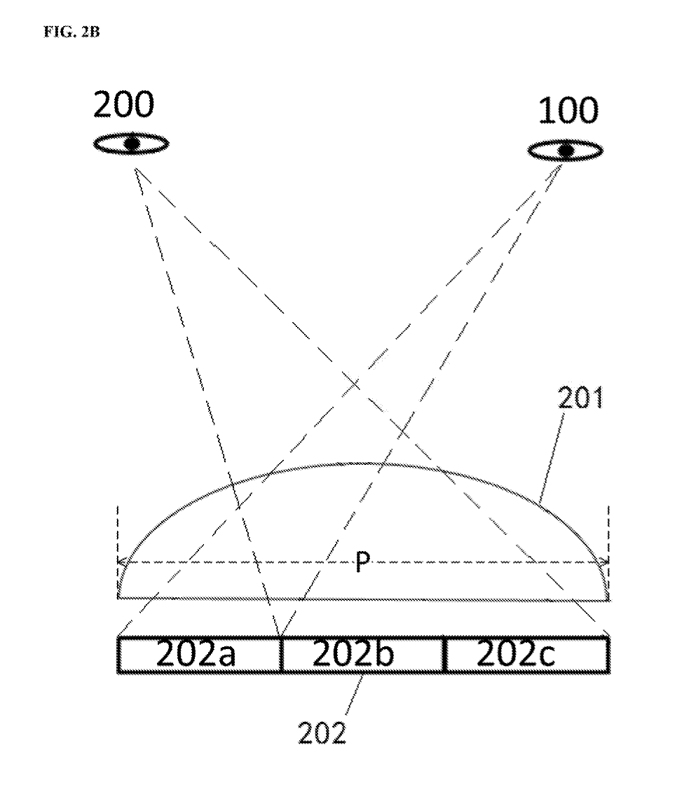

FIG. 3 is a schematic diagram illustrating an increased focal length in a grating layer in some embodiments according to the present disclosure. Referring to FIG. 3, a normal viewing distance between the first view zone 100 and the second view zone 200 and the display panel is maintained at a distance L0. In a conventional three-dimensional display panel assembly, a grating unit is configured to direct light emitted from two adjacent subpixels into a first view zone 100 and a second view zone 200. A focal length of the grating unit to satisfy a reading distance L1 (defined as a normal distance between the view zones and the grating unit) is a first focal length d1. In the present three-dimensional display panel assembly, a grating unit is configured to direct light emitted from three adjacent subpixels into a first view zone 100 and a second view zone 200. A focal length of the grating unit to satisfy a reading distance L2 (defined as a normal distance between the view zones and the grating unit) is a second focal length d2. The difference between the focal lengths d1 and d2 is Δd. Thus, the focal length required to achieve a same viewing distance L0 between the viewer's eyes and the display panel can be much increased (e.g., from d1 to d2) in the present three-dimensional display panel assembly.

For example, a normal viewing distance for a mobile phone is in the range of approximately 300 mm to approximately 400 mm. To achieve this viewing distance in a conventional three-dimensional display panel assembly in which each grating unit is configured to direct light emitted from two adjacent subpixels into the view zones, the focal length would be in a range of approximately 0.18 mm to approximately 0.25 mm. However, the distance between a subpixel and a light emitting surface in a display panel (e.g., a mobile phone) is at least approximately 0.4 mm (e.g., a sum of thicknesses of a glass cover, a polarizer, and a film). Apparently, the normal viewing distance cannot be achieved in the conventional three-dimensional display panel assembly. For a viewer to get good three-dimensional viewing effects, the viewer has to view the image at a much shorter viewing distance, the user viewing experience is severely compromised.

In the present three-dimensional display panel assembly, each grating unit is configured to direct light emitted from at least three adjacent subpixels into the view zones, e.g., the grating pitch of each grating unit is a substantially the same as a width of the at least three adjacent subpixels. While maintaining a normal viewing distance of 300 mm to 400 mm, the increase in the grating pitch results in an increase in the focal length (e.g., from d1 to d2 as shown in FIG. 3). For example, in a display apparatus (e.g., a mobile phone) having a resolution of 3840×2160, if the grating unit is designed to direct only two adjacent subpixels into the left eye and the right eye, a distance between the grating layer and the display panel (e.g., a focal length) of approximately 0.22 mm is required to achieve a viewing distance of approximately 350 mm. If the grating unit is designed to direct at least three adjacent subpixels into the left eye and the right eye, then a distance between the grating layer and the display panel of approximately 0.42 mm can achieve a viewing distance of approximately 350 mm. By having a distance between the grating layer and the display panel larger than 0.4 mm to achieve a viewing distance of approximately 350 mm, the grating layer can be assembled with most of display apparatuses such as mobile phones and tablet computers to achieve a normal viewing distance without substantial structural redesign of the display apparatus, in which the distance between a subpixel and a light emitting surface of the display panel is at least approximately 0.4 mm. Thus, excellent three-dimensional effects can be obtained at a normal viewing distance, greatly enhancing the user experience.

In some embodiments, each grating unit is configured to direct light emitted from four adjacent subpixels into a first view zone and a second view zone on a side of the grating layer distal to the display panel. Optionally, the four adjacent subpixels are four adjacent subpixels along the first direction (e.g., the longitudinal direction) of the display panel. Optionally, the four adjacent subpixels are four adjacent subpixels along the second direction (e.g., the lateral direction) of the display panel. Optionally, each grating unit is configured to direct light emitted from one subpixel out of the four adjacent subpixels into the first view zone, and direct light emitted from the other three adjacent subpixels out of the four adjacent subpixels into the second view zone. Optionally, each grating unit is configured to direct light emitted from two adjacent subpixels out of the four adjacent subpixels into the first view zone, and direct light emitted from the other two adjacent subpixels out of the four adjacent subpixels into the second view zone. Optionally, the first view zone is a left eye view zone, and the second view zone is a right eye view zone. Optionally, the first view zone is a right eye view zone, and the second view zone is a left eye view zone.

In some embodiments, each grating unit is configured to direct light emitted from three adjacent subpixels into a first view zone and a second view zone on a side of the grating layer distal to the display panel. Optionally, the three adjacent subpixels are three adjacent subpixels along the first direction (e.g., the longitudinal direction) of the display panel. Optionally, the three adjacent subpixels are four adjacent subpixels along the second direction (e.g., the lateral direction) of the display panel. Optionally, each grating unit is configured to direct light emitted from one subpixel out of the three adjacent subpixels into the first view zone, and direct light emitted from the other two adjacent subpixels out of the three adjacent subpixels into the second view zone. Optionally, the first view zone is a left eye view zone, and the second view zone is a right eye view zone. Optionally, the first view zone is a right eye view zone, and the second view zone is a left eye view zone.

In some embodiments, each grating unit is configured to direct light emitted from six adjacent subpixels into a first view zone and a second view zone on a side of the grating layer distal to the display panel. Optionally, the six adjacent subpixels are four adjacent subpixels along the first direction (e.g., the longitudinal direction) of the display panel. Optionally, the six adjacent subpixels are four adjacent subpixels along the second direction (e.g., the lateral direction) of the display panel. Optionally, each grating unit is configured to direct light emitted from two adjacent subpixels out of the six adjacent subpixels into the first view zone, and direct light emitted from the other four adjacent subpixels out of the six adjacent subpixels into the second view zone. Optionally, the first view zone is a left eye view zone, and the second view zone is a right eye view zone. Optionally, the first view zone is a right eye view zone, and the second view zone is a left eye view zone.

In some embodiments, the grating layer is a parallax barrier grating layer, each of the plurality of grating units includes a barrier part and a slit part, the slit part is light transmissive, the barrier part is light blocking. A barrier part and a slit part in each grating unit corresponds to at least three adjacent subpixels, e.g., configured to direct light emitted from at least three adjacent subpixels into a first view zone and a second view zone on a side of the grating layer distal to the display panel. Optionally, each cycle of the parallax barrier grating layer (each cycle including a barrier part and a slit part) has a cycle length (which is the grating pitch of a parallax barrier grating layer) substantially the same as a width of the at least three adjacent subpixels. Optionally, the parallax barrier grating layer includes a plurality of slits arranged along a longitudinal direction of the display panel, each of the plurality of slits extending along a lateral direction of the display panel. Optionally, the parallax barrier grating layer includes a plurality of slits arranged along a lateral direction of the display panel, each of the plurality of slits extending along a longitudinal direction of the display panel.

Optionally, the parallax barrier grating layer includes a plurality of slits arranged substantially along a longitudinal direction of the display panel, each of the plurality of slits forming an acute angle with a lateral direction of the display panel. Optionally, the parallax barrier grating layer includes a plurality of slits arranged substantially along a lateral direction of the display panel, each of the plurality of slits forming an acute angle with a longitudinal direction of the display panel.

In some embodiments, the grating layer is a lenticular lens grating layer, each of the plurality of grating units includes a cylindrical lens. Each cylindrical lens corresponds to at least three adjacent subpixels, e.g., configured to direct light emitted from at least three adjacent subpixels into a first view zone and a second view zone on a side of the grating layer distal to the display panel. Optionally, each cylindrical lens has a lens pitch (which is the grating pitch of a lenticular lens grating layer) substantially the same as a width of the at least three adjacent subpixels. Optionally, the lenticular lens grating layer includes a plurality of cylindrical lenses arranged along a longitudinal direction of the display panel, a central axis of each of the plurality of cylindrical lenses extending along a lateral direction of the display panel. Optionally, the lenticular lens grating layer includes a plurality of cylindrical lenses arranged along a lateral direction of the display panel, a central axis of each of the plurality of cylindrical lenses extending along a longitudinal direction of the display panel.

Optionally, the lenticular lens grating layer includes a plurality of cylindrical lenses arranged substantially along a longitudinal direction of the display panel, a central axis of each of the plurality of cylindrical lenses forming an acute angle a lateral direction of the display panel. Optionally, the lenticular lens grating layer includes a plurality of cylindrical lenses arranged substantially along a lateral direction of the display panel, a central axis of each of the plurality of cylindrical lenses forming an acute angle a longitudinal direction of the display panel.

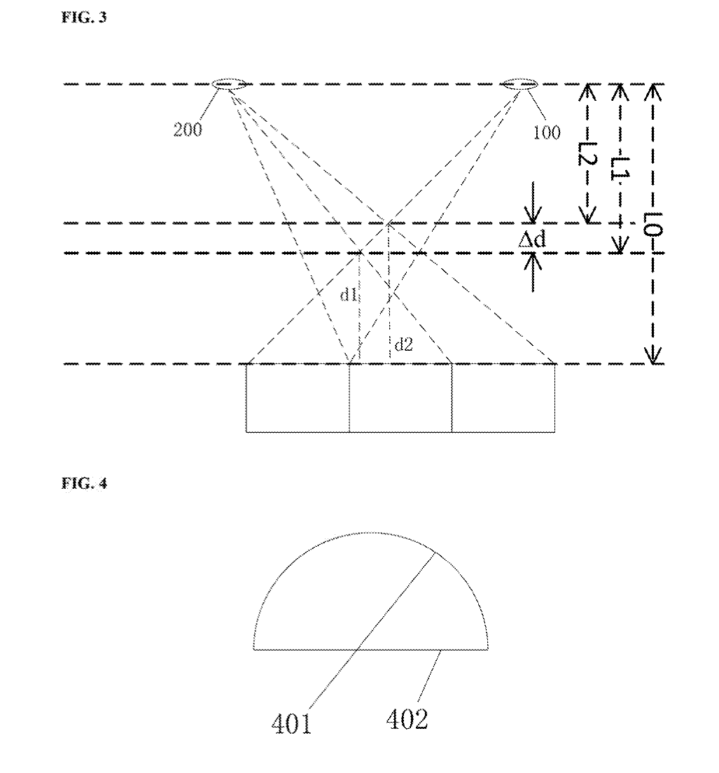

FIG. 4 is a diagram illustrating the structure of a cylindrical lens in some embodiments according to the present disclosure. Referring to FIG. 4, the cylindrical lens in some embodiments includes a cylindrically curved plane 401 and a substantially flat plane 402. In a three-dimensional display panel assembly having a lenticular lens grating layer including a plurality of cylindrical lenses, the substantially flat plane 402 is on a side proximal to the light emitting side of the display panel, and the cylindrically curved plane 401 is on a side distal to the light emitting side of the display panel. Each cylindrically curved plane 401 corresponds to at least three adjacent subpixels, e.g., configured to direct light emitted from at least three adjacent subpixels into a first view zone and a second view zone on a side of the grating layer distal to the display panel.

In some embodiments, each of the plurality of grating units has a viewing range less than a distance between a first view zone and a second view zone at a normal viewing distance. As used herein, the term “viewing range” refers to a normal distance between an edge of the viewing window to a central plane of the individual grating unit normal to the viewing window. Optionally, the viewing range is half of a width or a diameter of the viewing window. As used herein, the term “viewing window” refers to a region at a reading distance in a plane substantially parallel to the light emitting surface of the display panel in which light passes through an individual grating unit may be received. Optionally, each of the plurality of grating units has a viewing range less than a normal interpupillary distance of a human. Optionally, a normal interpupillary distance is approximately 65 mm. Optionally, the normal viewing distance is in a range of approximately 300 mm to approximately 400 mm. Optionally, the normal viewing distance is approximately 350 mm. In some embodiments, each of the plurality of grating units has a viewing range of approximately 55 mm to approximately 60 mm at a viewing distance in a range of approximately 300 mm to approximately 400 mm. Optionally, each of the plurality of grating units has a viewing range of approximately 55 mm to approximately 60 mm at a viewing distance of approximately 350 mm.

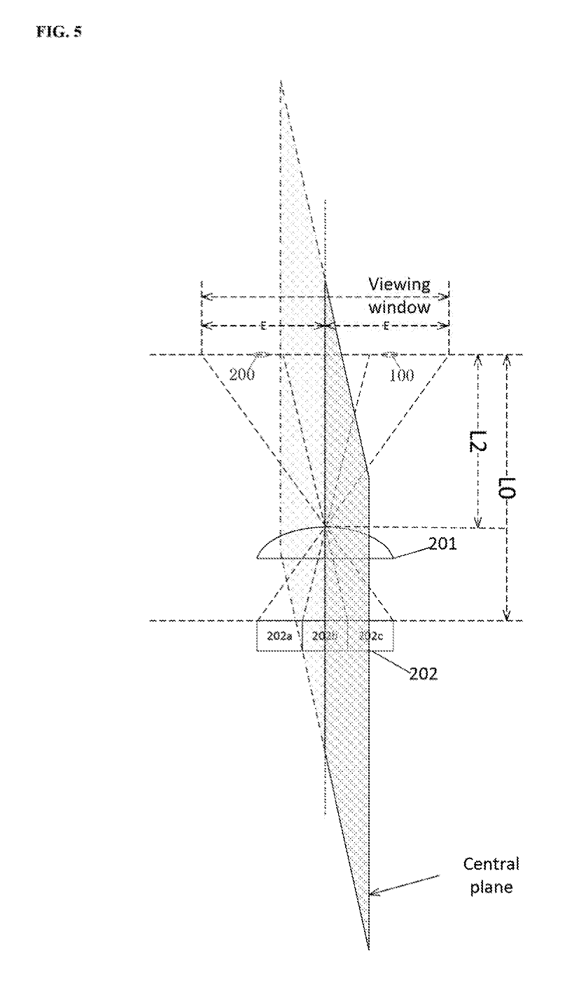

FIG. 5 is a diagram illustrating a viewing range in a three-dimensional display panel assembly in some embodiments according to the present disclosure. Referring to FIG. 5, the grating unit 201 corresponds to three adjacent subpixels 202. The grating unit 201 is configured to direct light emitted from the three adjacent subpixels 202 into a first view zone 100 and a second view zone 200. A viewing window corresponding to the grating unit 201 is a region at a reading distance L2 (corresponding to a viewing distance L0) in a plane substantially parallel to the light emitting surface of the display panel (not explicitly shown in FIG. 5). As illustrated in FIG. 5, the viewing window is defined as a region in which light passes through an individual grating unit 201 may be received. The view range (e.g., E1 or E2 in FIG. 5) is a normal distance between an edge of the viewing window to a central plane of the individual grating unit normal to the viewing window. Optionally, the central plane is also a central plane of the subpixel 202b if the subpixel 202b is aligned with the grating unit 201. Optionally, E1 is substantially the same as E2. Optionally, E1 is different from E2.

In some embodiments, the viewing range is less than a normal interpupillary distance of a human at a reading distance in a range of approximately 300 mm to approximately 400 mm. Optionally, a normal interpupillary distance is approximately 65 mm. Optionally, the viewing range of a grating unit is in a range of approximately 55 mm to approximately 60 mm at a viewing distance of approximately 350 mm. Optionally, the grating unit is configured to direct light emitted from two adjacent subpixels out of the three adjacent subpixels into the first view zone, and direct light emitted from the other subpixel out of the three adjacent subpixels into the second view zone. By having the viewing range less than a interpupillary distance of a human, the first view zone can be offset from a position of a black matrix between two adjacent subpixels corresponding to the first view zone, achieving a better viewing experience.

For example, in a mobile phone having a resolution of 3840×2160, a distance between the grating layer and the display panel (e.g., a focal length) of approximately 0.22 mm is required to achieve a viewing distance of approximately 350 mm, if the grating unit is designed to direct only two adjacent subpixels into the left eye and the right eye. If the grating unit is designed to direct at least three adjacent subpixels into the left eye and the right eye, then a distance between the grating layer and the display panel of approximately 0.42 mm can achieve a viewing distance of approximately 350 mm. The grating layer can be assembled with the mobile phone to achieve a normal viewing distance without substantial structural redesign of the mobile phone.

Optionally, the display panel has a rectangular shape.

Optionally, the display panel further includes a color filter layer. Optionally, a normal distance between the color filter layer and the grating layer is greater than approximately 0.4 mm, e.g., in a range of approximately 0.4 mm to approximately 0.45 mm.

In another aspect, the present disclosure provides a method of fabricating a three-dimensional display panel assembly. In some embodiments, the method includes providing a display panel comprising a light emitting side and an array of subpixels arranged in a matrix along a first direction and a second direction; and forming a grating layer on the light emitting side of the display panel, the grating layer comprising a plurality of grating units, each of the plurality of grating units configured to direct light emitted from at least three adjacent subpixels into a first view zone and a second view zone on a side of the grating layer distal to the display panel. Optionally, the step of forming the grating layer includes providing a grating layer having a grating pitch substantially the same as a width of the at least three adjacent subpixels; and adhering the grating layer to the light emitting side of the display panel.

Optionally, prior to adhering the grating layer to the light emitting side of the display panel, the method further includes arranging the grating layer so that the plurality of grating units are arranged along a longitudinal direction of the display panel, each of the plurality of grating units extending along a lateral direction of the display panel.

Optionally, prior to adhering the grating layer to the light emitting side of the display panel, the method further includes arranging the grating layer so that the plurality of grating units are arranged substantially along a longitudinal direction of the display panel, each of the plurality of grating units forming an acute angle with a lateral direction of the display panel.

In another aspect, the present disclosure provides a three-dimensional display apparatus having a three-dimensional display panel assembly described herein or fabricated by a method described herein. Examples of appropriate display apparatuses include, but are not limited to, an electronic paper, a mobile phone, a tablet computer, a television, a monitor, a notebook computer, a digital album, a gaming system, etc.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”. “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A three-dimensional display panel assembly, comprising:
a display panel comprising a light emitting side and an array of subpixels arranged in a matrix along a first direction and a second direction; and
a grating layer on the light emitting side of the display panel comprising a plurality of grating units, each of the plurality of grating units configured to direct light emitted from at least three adjacent subpixels into a first view zone and a second view zone on a side of the grating layer distal to the display panel.

2. The three-dimensional display panel assembly of claim 1, wherein each of the plurality of grating units has a grating pitch substantially the same as a width of the at least three adjacent subpixels.

3. The three-dimensional display panel assembly of claim 1, wherein the plurality of grating units are arranged along a longitudinal direction of the display panel, each of the plurality of grating units extending along a lateral direction of the display panel.

4. The three-dimensional display panel assembly of claim 1, wherein each of the plurality of grating units configured to direct light emitted from at least a first subpixel of the at least three adjacent subpixels into the first view zone, and direct light emitted from at least a second subpixel of the at least three adjacent subpixels into the second view zone.

5. The three-dimensional display panel assembly of claim 1, wherein the at least three adjacent subpixels are at least three adjacent subpixels along the first direction.

6. The three-dimensional display panel assembly of claim 1, wherein the at least three adjacent subpixels are at least three adjacent subpixels along the second direction.

7. The three-dimensional display panel assembly of claim 1, wherein the at least three adjacent subpixels are 3N adjacent subpixels, N is a positive integer.

8. The three-dimensional display panel assembly of claim 7, wherein N=1.

9. The three-dimensional display panel assembly of claim 1, wherein the grating layer is a parallax barrier grating layer, each of the plurality of grating units comprises a barrier part and a slit part, the slit part is light transmissive, the barrier part is light blocking.

10. The three-dimensional display panel assembly of claim 9, wherein the parallax barrier grating layer comprises a plurality of slits arranged along a longitudinal direction of the display panel, each of the plurality of slits extending along a lateral direction of the display panel.

11. The three-dimensional display panel assembly of claim 1, wherein the grating layer is a lenticular lens grating layer, each of the plurality of grating units comprises a cylindrical lens.

12. The three-dimensional display panel assembly of claim 11, wherein the lenticular lens grating layer comprises a plurality of cylindrical lenses arranged along a longitudinal direction of the display panel, a central axis of each of the plurality of cylindrical lenses extending along a lateral direction of the display panel.

13. The three-dimensional display panel assembly of claim 1, wherein each of the plurality of grating units has a viewing range of approximately 55 mm to approximately 60 mm at a viewing distance in a range of approximately 300 mm to approximately 400 mm.

14. The three-dimensional display panel assembly of claim 1, wherein the display panel further comprising a color filter layer; and
a normal distance between the color filter layer and the grating layer is greater than approximately 0.4 mm.

15. The three-dimensional display panel assembly of claim 1, wherein the plurality of grating units are arranged substantially along the first direction of the display panel, each of the plurality of grating units forming an acute angle with the second direction of the display panel.

16. A three-dimensional display apparatus, comprising a three-dimensional display panel assembly of claim 1.

17. A method of fabricating a three-dimensional display panel assembly, comprising:
providing a display panel comprising a light emitting side and an array of subpixels arranged in a matrix along a first direction and a second direction; and
forming a grating layer on the light emitting side of the display panel, the grating layer comprising a plurality of grating units, each of the plurality of grating units configured to direct light emitted from at least three adjacent subpixels into a first view zone and a second view zone on a side of the grating layer distal to the display panel.

18. The method of claim 17, wherein forming the grating layer comprises
providing a grating layer having a grating pitch substantially the same as a width of the at least three adjacent subpixels; and
adhering the grating layer to the light emitting side of the display panel.

19. The method of claim 18, prior to adhering the grating layer to the light emitting side of the display panel, further comprising arranging the grating layer so that the plurality of grating units are arranged along a longitudinal direction of the display panel, each of the plurality of grating units extending along a lateral direction of the display panel.

20. The method of claim 18, prior to adhering the grating layer to the light emitting side of the display panel, further comprising arranging the grating layer so that the plurality of grating units is arranged substantially along the first direction of the display panel, each of the plurality of grating units forming an acute angle with the second direction of the display panel.
